(19) United States
(12) Patent Application Publication
(10) Pub. No.: US 2012/0102304 A1
(43) Pub. Date: Apr. 26, 2012

(54) Behavior-Based Data Configuration System and Method

(75) Inventor: Scott Brenner Brave, San Jose, CA (US)

(73) Assignee: Baynote, Inc., San Jose, CA (US)

(21) Appl. No.: 12/912,608

(22) Filed: Oct. 26, 2010

(51) Int. Cl. G06F 9/00

(52) U.S. Cl. 713/1

(57) ABSTRACT

A system and method are provided for configuring data elements in a computer application such as menu items, links to purchase products, options, links to information, and user commands based on the behavior of users in the application. Information associated with the behavior of multiple users and information associated with a finite set of data elements in the computer application are analyzed to determine a configuration of the data elements such that user access to relevant information is improved.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of electronic access to information and more particularly to improving user ability to locate content in internet and computer applications.

### BACKGROUND

Among the most impacting technological progress in this century has been in the field of information technology. As the power of computing and the internet has evolved, fast, convenient, and accurate location and delivery of information has become a primary objective of much of the internet and software industry.

In many applications, providing a consumer relevant information quickly and conveniently is a critical determinant of success. Namely, as the population has become more and more accustomed to the convenience of software and internet applications, the consumer's attention span with respect to such applications has declined. Today, consumers expect to find what they need immediately and conveniently. Accordingly, users of a web or a computer application are likely to become frustrated and discouraged if they have to spend time navigating and sifting through the application's contents to find sought information.

Existing applications attempt to bring content to users by organizing the content according to what the application administrators envision is the most convenient configuration for the average user. However, such methods fail to take into account the peculiarities of a given user, the constant change of user preferences with time, subconscious elements of user preferences, and myriad other unexpected factors that an administrator may overlook when configuring an application.

What is needed is a system and method for organizing and configuring the information in computer and internet applications so that the application adapts to users based on the users' behavior in the application to bring relevant content to the users. As will be demonstrated, the present invention satisfies this need.

### BRIEF DESCRIPTION OF THE DRAWINGS

FIG. 1 is a block diagram illustrating an example environment capable of implementing the systems and methods discussed herein.

FIG. 2 is a block diagram illustrating an example system of a client module and a behavior analysis module.

FIG. 3 is a block diagram illustrating various components of a behavior analysis module, which includes a communication module, a processor, and a memory.

FIG. 4 is a flow diagram illustrating an embodiment of a procedure for producing data element configurations in the behavior analysis module.

FIG. 5 is a flow diagram illustrating an embodiment of a procedure for obtaining a data element configuration in a client module.

FIG. 6 illustrates an example page in an application prior to reconfiguration of data elements.

FIG. 7 illustrates an example page in an application after reconfiguration of data elements.

FIG. 8 is a block diagram illustrating an example computing device.

### DETAILED DESCRIPTION

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . .”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The systems and methods described herein provide an accurate and efficient way to configure content in internet and computer applications to allow users of such applications to quickly and conveniently locate relevant data or functions. In various embodiments, the described systems and methods can comprise gathering information about a finite set of data elements in a computer application, gathering information about user behavior in the application, and producing a configuration of the data elements to enhance user access to relevant content.

As used herein, the term “application” refers to any computer-based application or web-based application. Examples of web-based applications can be retailer websites, enterprise websites, information websites, and any other websites. Examples of computer-based applications can be word processing software, tax software, or other computer programs.

As used herein, the terminology “relevant content” or “relevant information” refers to content that is predicted to produce a desirable result for the user, for the host of an application, or for another party when the “relevant content” is made accessible to the user. For example, relevant content can be a link to a product that a user seeks. Alternatively, relevant content can be a link to a product that the user does not seek but where displaying the link to the user is predicted to benefit the host of the application; for example, by motivating the user to buy a product from the host.

As used herein, the term “data element” refers to a configurable, visual object in an application. In various embodiments, data elements can be user commands, options, menu items, raw data, digital data sequences, or other types of data or related items. For example, data elements can be options in a drop-down menu in an application, such as options for different forms in tax software or links to different pages; a set of tabs, each of which tabs can lead to another set of options when opened; a list of links that guides a user through an application's contents, such as in enterprise software; a list of options for a particular product being sold in an application, such as colors and features; or a list of different products on sale. The data element itself can appear as text, a graphic, a photograph, or any other visual element.

For example, in a tax software application, the tax forms and the information that users look for may vary depending on the time of the year, particularly in relation to tax season. Hence, the menus and user commands in the application may need to be rearranged throughout the year to bring most relevant content to the user into the most accessible configuration—such as by putting it in the top of a menu, on the top of a list, or on the main page of the application. Similarly, on a retail website, such as a personal computer retail website, the consumer may have several products to choose from and several options to choose from in selecting each product, including various features, accessories, colors, and options such as memory size and processor speed. To assist the consumer through the plethora of options, the options can be configured with the most likely preferred options being placed in the most accessible configuration, such as at the top of a list of options.

In various embodiments, the configuration of data elements in an application can be updated on a periodic basis, such as daily or weekly. In other embodiments, the configuration can be updated continuously. Further, the configuration can be updated based on the type of user, user preferences, attributes, or other user properties. Namely, a property regarding the user can be observed, such as through the user's behavior in the application, an existing profile of the user, or other available information regarding the user. The data elements can then be configured for the particular property regarding the user. The data configuration can be based on the observed behaviors of other users with similar properties. For example, if it is observed that a particular user selects content that has to do with corporate tax refunds in a piece of tax software, or if a saved profile regarding the user indicates that the user is interested in corporate tax refund content, then the data elements in the software can be configured to enhance access to content related to corporate tax refunds, the configuration can be based on the behaviors of other users who are interested in corporate tax refunds. Similarly, if it is observed that a particular user is interested in content that has to do with laptop computers on a computer retailer website, then the data elements in the application can be configured to enhance access to content related to laptop computers.

In various embodiments, configuring data elements can comprise changing the location of the elements in the application and/or changing the appearance of the data elements. For example, configuring data elements can comprise rearranging the location of the data elements in a list or a menu; rearranging which page of an application certain data elements are displayed on; rearranging where on a page, or on which page, a graphic data element is displayed; and/or rearranging timing of when certain data elements appear. In other embodiments, configuring data elements can comprise changing the appearance of the data elements by modifying the element itself. For example, configurable attributes of a data element can include the color of the data element, the size of the data element, the font style and font size of a written data element, the particular graphic associated with the data element, accompanying sounds for the data element, and motion characteristics of the data element such as vibrating or moving texts or graphics.

In various embodiments, configuring a set of data elements can comprise selecting a subset of the total set of data elements. For example, in a set of 20 data elements, only 10 may be chosen to be displayed. In such cases, various routines, which are known in the art, can be used to periodically circulate the non-displayed data elements into the configuration to determine if user tendencies towards those elements have changed and/or whether those elements should become part of succeeding configurations. Those skilled in the art will recognize the above as a time-, user-, and context-dependent multi-armed bandit problem requiring a “bandit strategy” that balances between exploitation of information already learned and exploration of new options or changing efficacy of existing options.

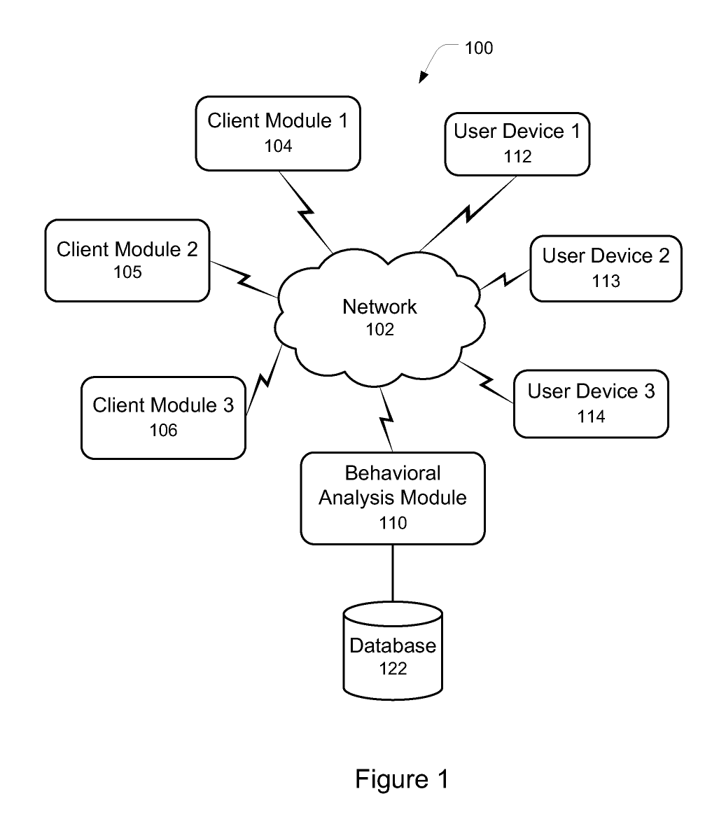

FIG. 1 is a block diagram illustrating an example environment 100 capable of implementing the systems and methods discussed herein. A data communication network 102, such as the Internet, communicates data among a variety of devices, including client modules, user devices, behavioral analysis modules, and so forth. Data communication network 102 may be a combination of two or more networks communicating data using various communication protocols and any communication medium.

The embodiment of FIG. 1 includes client modules 104, 105, and 106, which represent one or more locations that contain applications with content that can be configured according to various embodiments of the invention. Client modules 104, 105, and 106 can be web servers, enterprise systems, personal computers, and any other systems that can contain applications with configurable content. Environment 100 also includes behavior analysis module 110, which can receive data associated with user behavior and data associated with a finite set of data elements and distribute data element configurations to client modules 104, 105, and 106, and other content sources through the network 102. Client modules 104, 105, and 106 can be accessed by multiple user devices (e.g., user devices 112, 113, and 114 shown in FIG. 1), which are seeking specific content. A user can search or browse through content on applications on the client modules 104, 105, and 106. In various embodiments, users can also access applications directly on the client modules 104, 105, and 106. The behavior of the users on the applications with respect to a finite set of data elements in the application can be observed on the client modules 104, 105, and 106 and the behavior observations can be conveyed to the behavioral analysis module 110. The behavior observations can be analyzed in the behavioral analysis module 110 and a configuration of the finite set of data elements can be produced to improve user access to relevant content. The produced configuration of the finite set of data elements can be conveyed from the behavior analysis module 110 to client modules 104, 105, and 106 over the network 102. The client modules 104, 105, and 106 can arrange content in applications according to the conveyed configuration data. In various embodiments, client modules 104, 105, and 106 can request configurations of the finite set of data elements from the behavior analysis module 110. In other embodiments, client modules 104, 105, and 106 can receive configurations of the finite set of data elements from the behavior analysis module 110 on a periodic basis.

Data associated with user behavior that is conveyed to the behavior analysis module 110 can comprise any user actions that can be observed in applications on the client modules. For example . . . .

Depending on the type of data element, user behaviors can include interaction with the data element or lack of interaction with an available data element, including repeated interactions and time-profiles of such repeated behaviors; selection of a data element or sub-element such as clicking or otherwise choosing a menu option or radio button, starting or pausing a video; information entered into a data element, such as a search query or free text comment; movement of the data element, such as drag and drop; highlighting, copying, and pasting of data elements; changing the appearance of data elements, such as hiding, minimizing, maximizing. Interaction with data elements may also lead to the presentation of content or further data elements with which the user may also interact. User behavior on subsequent content and data elements may also be associated with the parent data element or elements. For example, selection of a particular data element may eventually lead to purchase of an item or usage of content. This behavior may impact subsequent configuration of the initial data element selected. For content or large data elements, user behavior may also include time spent interacting with the object, the number and frequency of interaction, amount of the element seen, and any interactions with sub-elements or sub-content.

Numerous methods are available and well known in the art for collecting behavior data in applications and will not be covered here in detail as such details are not considered necessary for a complete understanding of the invention.

Data associated with the finite set of data elements that is conveyed to the behavior analysis module 110 can comprise, for example, any metadata associated with the data element, such as type of element as well as details regarding sub-elements and possible interactions a user may have with the element; details regarding the presentation of the element, including location, size, color, look- and feel, configuration, or other state information; groupings of data elements, including visual groupings or logical groupings and dependencies.

The data associated with user behavior can be analyzed to produce a configuration of data elements using various methods of content delivery optimization. For example, a variety of machine learning techniques such as reinforcement learning, Bayesian networks, neural networks, and genetic algorithms may be used to efficiently explore and exploit the space of configurations on a global, per-segment, per-user, or per-context basis. Other methods may be used to predict optimal configurations of elements based on user behaviors or other attributes, such as personalization and collaborative filtering techniques and variants thereof. Information retrieval, text-processing, and natural language processing techniques may also be employed to predict optimal configurations when the data elements include, effect, or lead to textual or verbal content or metadata. All of the above techniques may be used to predict optimal configurations, as well as interpret and learn from user behaviors on elements.

Numerous methods are available and well known in the art for content delivery optimization in applications and will not be covered here in detail as such details are not considered necessary for a complete understanding of the invention.

In addition to user behaviors associated with data elements and their configuration, additional information about users may be gathered to predict optimal configurations and organize learning related to specific elements and configurations. For example, demographic data or survey data may be collected on users and incorporated into the models. Offline behaviors such as purchase histories or location data may also be included. Online behaviors prior and subsequent to interaction with data elements may also be included.

In the preferred embodiment, in-application behaviors including interaction with data elements may be observed through APIs called by the application. On a website, this may be a JavaScript or image-based tag placed into the header or footer of the website. Logfiles may also be uploaded. Offline or other behaviors outside of the application may be uploaded through logfiles or other data transfer methods.

The information collected by the system, including user behaviors or other uploaded data may be analyzed and modeled using a variety of methods to predict the optimal configuration of data elements for a given user in a particular context.

Any type of data element that has multiple possible configurations and the potential for user interaction with the element may be optimized by the system. In the preferred embodiment, user interface elements are configured by the system including menu items, radio buttons, selection boxes, lists, and hyperlinks. The position and appearance of data elements within the user interface may also be configured.

In one example of configuring data elements, a communication first occurs between the application and the system. In this communication, the application sends available information about the user, context, and available data elements to the system. The system may then suggest an optimal or set of optimal configuration of those elements given all available data. The application then configures the data elements based on this suggestion and display the determined configuration to the user. A default configuration may also be determined as a fallback strategy if for any reason the system is not reachable or has no data with which to make a suggestion. This communication may occur in real time, but it may also occur in a batch or otherwise offline mode.

The application may make information available to the system outside of the client module. This may include any information about the application or users that the application or application owner has access to. The system may also aggregate information from multiple applications or gather information through other means, such as through experts or crawling and gather of online data, to inform the models.

In one embodiment of the invention, traditional HTML is augmented to enable dynamic configuration and adaptation of user interface elements on a website. This can be achieved with minimal additional effort by the web author. For example, the below HTML element is a standard method for creating menu items:

```
<ul id=“nav-menu”>
    <li id=“nav1”><a href=URL1>Nav1</a></li>
    <li id=“nav2”><a href=URL2>Nav2</a></li>
    <li id=“nav3”><a href=URL3>Nav3</a></li>
    <li id=“nav4”><a href=URL4>Nav4</a></li>
</ul>
```

With the inclusion of a single JavaScript file and minimal instrumentation of the HTML element, as indicated below, the menu item can now be made adaptive, such that it configures itself optimally based on the user and context.

```
<script src=“ahtml.js”></script>
<ul id=“nav-menu” class=”ahtml”>
    <li id=“nav1”><a href=URL1>Nav1</a></li>
    <li id=“nav2”><a href=URL2>Nav2</a></li>
    <li id=“nav3”><a href=URL3>Nav3</a></li>
    <li id=“nav4”><a href=URL4>Nav4</a></li>
</ul>
```

The JavaScript file includes the logic for observing user behavior with the data elements as well as all other behaviors on the website or known to the website. The JavaScript file may be hosted locally or remotely. The JavaScript file also includes the logic for contacting the system to retrieve an optimal configuration of the menu given the user and context. In one embodiment, the JavaScript file will hide the instrumented menu list, contact the system, reorder menu items and then unhide and display the optimized order. If the system is unreachable for any reason, the existing menu list will be unhidden and displayed with the default order. Any HTML element including radio buttons, dropdowns or divs may be easily adapted in this way. For example, a user who has been to the website five times, lives in New York and arrived at the site from a search on “flights to Las Vegas” may see a different ordering of menu items then a user who is on the site for the first time and has interacted with two pages within the site that are related to sunny beaches. With minimal involvement from the website author, an entire website and user experience can become adaptive to user needs and contexts in real time.

A database 122 is coupled to communicate with behavior analysis module 110, as shown in FIG. 1. Database 122 stores various data and/or information related to application content, data elements, user behavior on applications, data element configurations, and related data. Information from client modules 104, 105, and 106 regarding data associated with user behavior and data associated with data elements can be stored in database 122.

Although environment 100 illustrates three client modules 104, 105, and 106; one behavioral analysis module, 110; and three user devices 112, 113, and 114, particular environments may include any number of client modules, behavioral modules, user devices, and other devices.

Although behavior analysis module 110; client modules 104, 105, and 106; user devices 112, 113, and 114; and database 122 are shown in FIG. 1 as separate components, in particular implementations, any two or more of these components can be combined into a single device or system.

Various APIs (application programming interfaces) are used to communicate data between the components and systems shown in FIG. 1. For example, APIs exist between behavioral analysis module 110 and client modules 104, 105, and 106. Other APIs exist between client modules 104, 105, and 106 and user devices 112, 113, and 114. In particular embodiments, these APIs are HTTP (Hypertext Transfer Protocol) Request/Response systems. In specific implementations, behavioral analysis module 110 communicates with client modules 104, 105, and 106 using JavaScript (with HTTP requests/responses) via AJAX (asynchronous JavaScript and XML) within a browser.

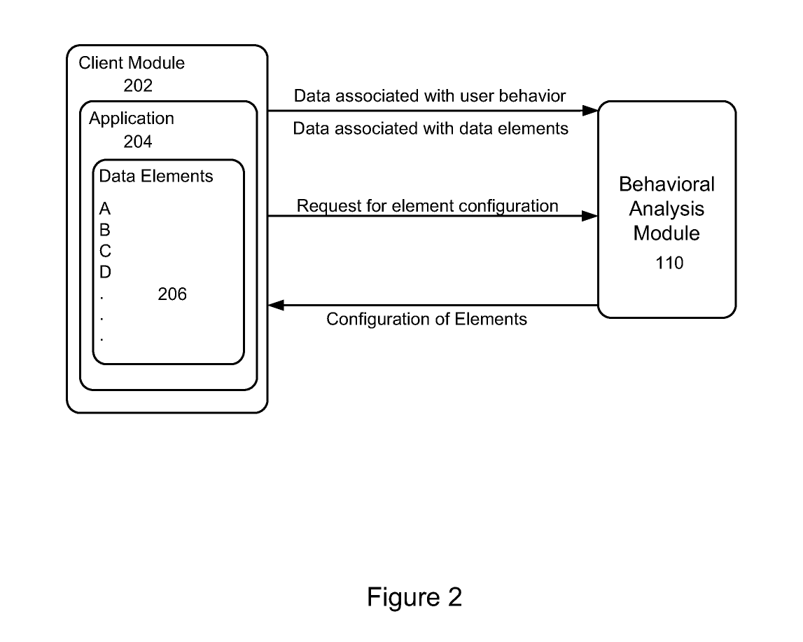

FIG. 2 is a block diagram illustrating an example system of a client module 202 and a behavior analysis module 110. The client module 202 can be any system hosting an application 204. The client module 202 can be a module such as the client modules 104, 105, and 106 illustrated in FIG. 1. For example, the client module 202 can be an enterprise, a computer, or a network of computers. The application 204 can be a computer program or a website. A finite set of data elements 206 can be contained in the application 204. As described above, the data elements can be various options, menu items, user commands, links, or other visual objects. Data associated with user behavior in the application 204 and data associated with data elements 206 can be conveyed to the behavior analysis module 110. A request for a configuration of data elements can be conveyed to the behavior analysis module 110. The behavior analysis module 110 can analyze the data associated with user behavior and the data associated with the set of data elements and convey a configuration of elements to the client module 202. The client module can configure the data elements according to the configuration received from the behavior analysis module 110.

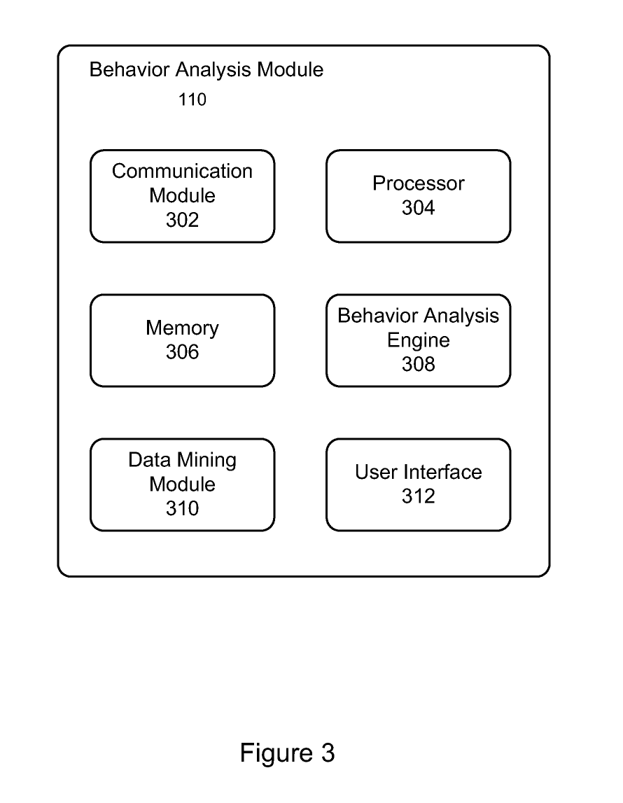

FIG. 3 is a block diagram illustrating various components of a behavior analysis module 110, which includes a communication module 302, a processor 304, and a memory 306. Communication module 302 allows behavior analysis module 110 to communicate with other devices and systems, such as client modules 104, 105, and 106 shown in FIG. 1. Processor 304 executes various instructions to implement the functionality provided by behavior analysis module 110. Memory 306 stores these instructions as well as other data used by processor 304 and other modules contained in behavior analysis module 110.

The behavior analysis module 110 also includes a behavior analysis engine 308, which analyzes available data associated with data elements and user behavior to produce data element configurations. The behavior analysis module 110 also includes a data mining module 310, which searches for data through knowledge bases, such as knowledge bases, such as the database 122 in FIG. 1 and retrieves data, such as data about user behavior and data element configurations. A user interface 312 allows administrators, web developers, and other users to interact with the various components of the behavior analysis module 110.

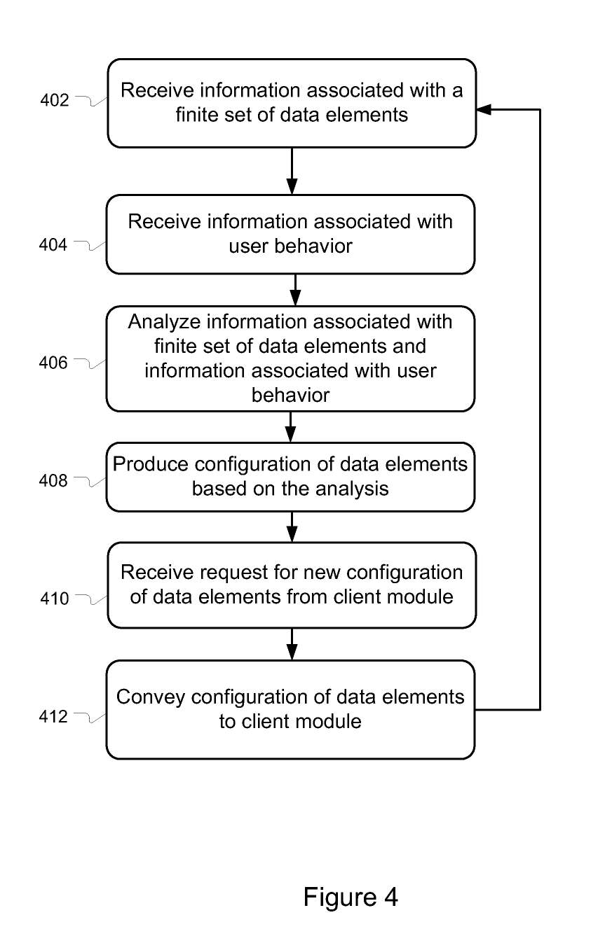

FIG. 4 is a flow diagram illustrating an embodiment of a procedure for producing data element configurations in the behavior analysis module 110. As illustrated in the example of FIG. 4, information associated with a finite set of data elements is received 402. Information associated with the behavior of users is received 404. The information associated with a finite set of data elements and the information associated with the behavior of users is analyzed 406. A configuration of data elements is produced based on the analysis 408. The behavior analysis module receives a request for a configuration of data elements from a client module 410. The produced configuration of the data elements is then conveyed to the client module 412. The data elements in the client module can be reconfigured according to the new configuration. Information associated with a finite set of data elements, where the data elements are in the new configuration, can be received 402.

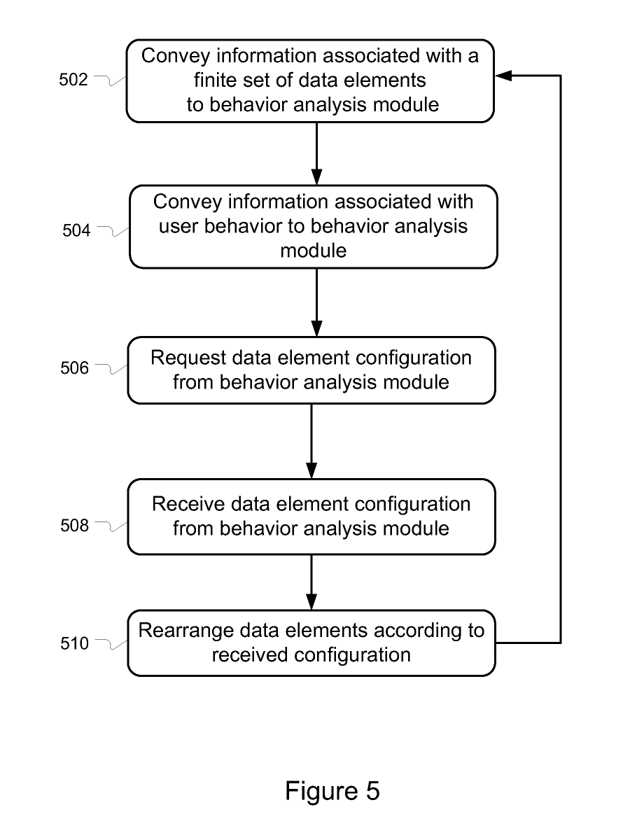

FIG. 5 is a flow diagram illustrating an embodiment of a procedure for obtaining a data element configuration in a client module. As illustrated in the example of FIG. 5, information associated with a finite set of data elements is conveyed to the behavior analysis module 502. Information associated with the behavior of users is also conveyed to the behavior analysis module 504. A configuration of data elements based on the information associated with a finite set of data elements and the information associated with the behavior of users is requested from the behavior analysis module 506. A configuration of data elements is then received from the behavior analysis module 508. The data elements in the application can be configured according to the received configuration 510. Information associated with a finite set of data elements, where the data elements are in the new configuration, can be conveyed to the behavior analysis module 502.

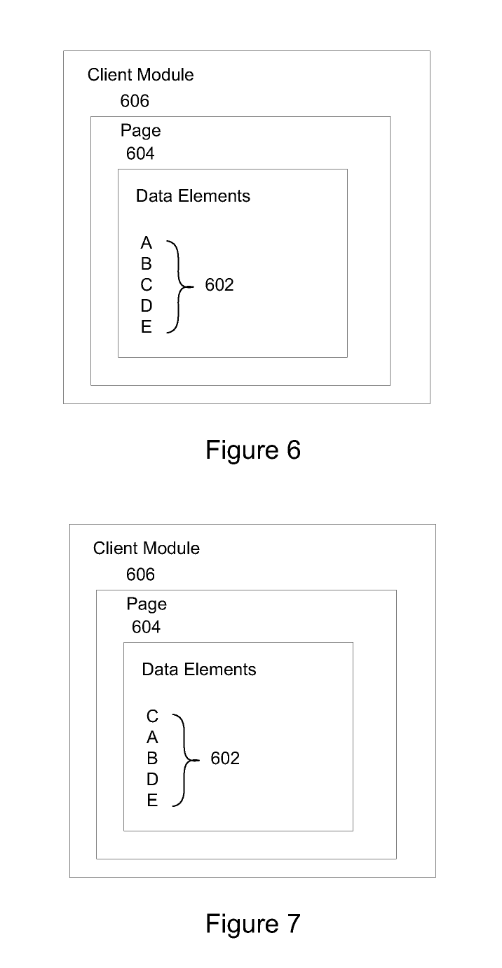

FIG. 6 illustrates an example page in an application prior to reconfiguration of data elements. As illustrated in the example, a set of data elements 602 can be displayed in a page 604 of an application within a client module 606. User behavior with respect to the data elements is observed and the behavioral data is stored. As described above, such observations can correspond to what proportion of users selected a particular data element or what proportion of users selected a particular data element and made a subsequent purchase. Data associated with the observed behavior and data associated with the current configuration of the data elements is conveyed to a behavior analysis module. In the behavior analysis module, a configuration of data elements that enhances access to relevant content for all users, a subset of users, or a particular user can be produced. The produced configuration is conveyed to the client module. In the client module, the data elements is reconfigured according to the conveyed configuration.

FIG. 7 illustrates an example page in an application after reconfiguration of data elements. As illustrated, the data elements 602 in FIG. 6 are reconfigured, resulting in the configuration of data elements 602 illustrated in FIG. 7. The configuration in FIG. 7 can correspond to the conveyed configuration from the behavior analysis module. For example, in the behavior analysis module, it can be observed that more purchases are made by users who select element “C” than any other element. Based on that observation, the behavior analysis module may produce a configuration placing element “C” at the top of the list to improve user access to element C. Such a configuration can be communicated to the client module, which client module can implement the conveyed recommendation as illustrated in FIG. 7.

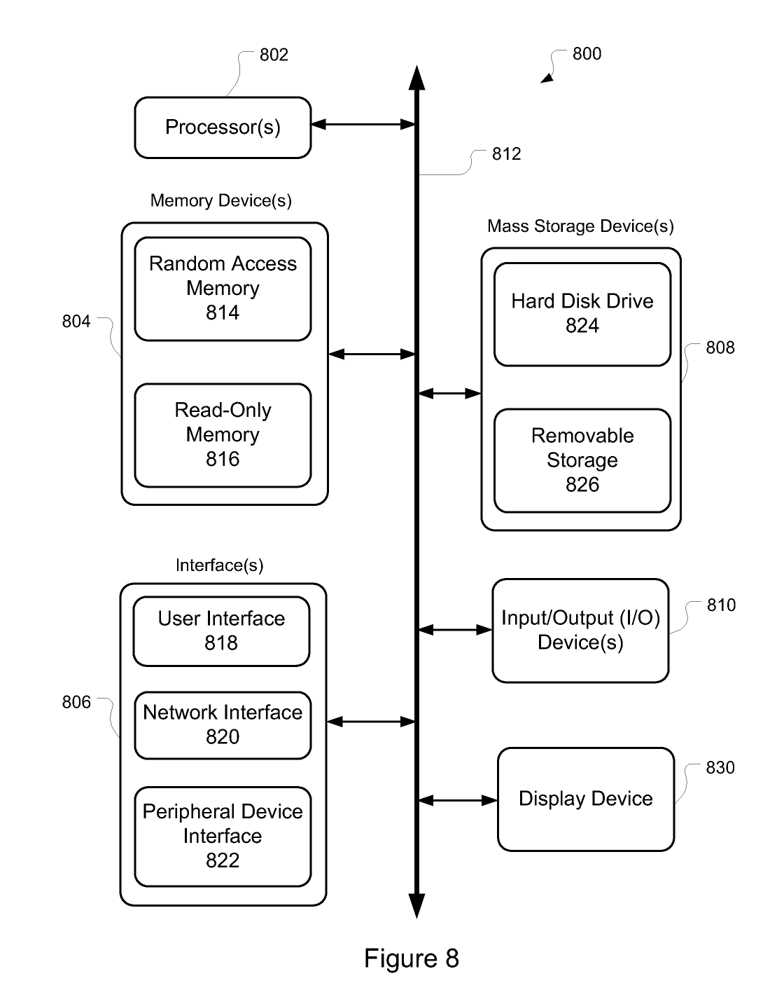

FIG. 8 is a block diagram illustrating an example computing device 800. Computing device 800 may be used to perform various procedures, such as those discussed herein. Computing device 800 can function as a server, a client, a user device, or any other computing entity. Computing device 800 can be any of a wide variety of computing devices, such as a desktop computer, a notebook computer, a server computer, a handheld computer, and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM)) 814 and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid state memory (e.g., Flash memory), and so forth. One type of mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interfaces include user interface 818 and peripheral device interface 822.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate configuring content of web and computer applications to improve user access to relevant content. Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A computer-implemented method comprising:
receiving information associated with behavior of multiple users;
receiving information associated with a finite set of data elements capable of being displayed in a computer application; and
determining a configuration of the finite set of data elements in a computer application based on the information associated with user behavior.

2. The method of claim 1, wherein the finite set of data elements are at least one of:
user commands and menu items.

3. The method of claim 1, wherein the finite set of data elements includes between 2 and 5 data elements.

4. The method of claim 1, wherein the finite set of data elements includes between 2 and 20 data elements.

5. The method of claim 1, wherein the finite set of data elements includes between 2 and 100 data elements.

6. The method of claim 1, wherein the configuration of the finite set of data elements comprises the location of the data elements in the application.

7. The method of claim 1, wherein determining a configuration of the finite set of data elements based on the information associated with user behavior comprises:
analyzing the information associated with user behavior to determine the relevancy of a data element to a user; and
determining a configuration of the finite set of data elements based on the determined relevancy of the data element to the user.

8. The method of claim 1, wherein determining a configuration of the finite set of data elements comprises selecting a subset of the finite set of data elements.

9. The method of claim 1, wherein the information associated with user behavior is received from a remote module over a network.

10. The method of claim 1, wherein the determined configuration of the finite set of data elements is communicated to a remote module in response to a request for such determined configuration of the finite set of data elements.

11. A computer-implemented method comprising:
collecting information associated with user behavior in an application;
communicating the information associated with behavior or multiple users to a behavior analysis module;
communicating information associated with a finite set of data elements to the behavior analysis module; and
receiving a configuration of the finite set of data elements from the behavior analysis module, wherein the configuration of the finite set of data elements is based on the communicated information associated with user behavior.

12. The method of claim 11, wherein the finite set of data elements are at least one of: user commands and menu items.

13. The method of claim 11, wherein the finite set of data elements includes between 2 and 5 data elements.

14. The method of claim 11, wherein the finite set of data elements includes between 2 and 20 data elements.

15. The method of claim 11, wherein the finite set of data elements includes between 2 and 100 data elements.

16. The method of claim 11, wherein the configuration of the finite set of data elements comprises the location of the data elements in an application.

17. The method of claim 11, wherein determining the configuration of the finite set of data elements based on the information associated with user behavior comprises:
analyzing the information associated with user behavior to determine the relevancy of a data element to a user; and
determining a configuration of the finite set of data elements based on the determined relevancy of the data element to the user.

18. The method of claim 11, wherein the configuration of the finite set of data elements comprises a subset of the finite set of data elements.

19. The method of claim 11, wherein the behavior analysis module is located remotely and information associated with user behavior is communicated to the behavior analysis module over a network.

20. The method of claim 11, wherein the configuration of the finite set of data elements is received from the behavior analysis module in response to a request sent to the behavior analysis module for such configuration of the finite set of data elements.

21. An apparatus comprising:
an application module configured to display a finite set of data elements; and
a behavior analysis module coupled to the application module, wherein the application module and the behavior analysis module are configured so that information associated with user behavior on the application module is communicated to the behavior analysis module and a configuration of the finite set of data elements is determined in the behavior analysis module based on the information associated with user behavior, which configuration of finite set of data elements is communicated to the application module.

22. The apparatus of claim 21, wherein the finite set of data elements comprises visual data elements displayed to a user in an application.

23. The apparatus of claim 21, wherein the configuration of the finite set of data elements comprises the location of the data elements in an application.

24. The apparatus of claim 21, wherein the behavior analysis module is configured so that the configuration of the finite set of data elements is determined based on the information associated with user behavior by analyzing the information associated with user behavior to determine the relevancy of each data element to a user and determining a configuration of the finite set of data elements based on the determined relevancy of each data element to a user.

25. The apparatus of claim 21, wherein a configuration of the finite set of data elements comprises a subset of the finite set of data elements.

26. The method of claim 21, wherein the application module and the behavior analysis module are connected by a network.

27. The method of claim 21, wherein the application module and the behavior analysis module are configured so that the determined configuration of the finite set of data elements is communicated to the application module in response to a request for such determined configuration of the finite set of data elements, which request is sent to the behavior analysis module from the application module.
